(19) United States
(12) Patent Application Publication
(10) Pub. No.: US 2023/0309627 A1
(43) Pub. Date: Oct. 5, 2023

(54) ELECTRONIC ATOMIZATION DEVICE

(71) Applicant: Shenzhen Smoore Technology Limited, Shenzhen (CN)

(72) Inventors: Zhihua WEN, Shenzhen (CN); Houlin CHEN, Shenzhen (CN); Haitao BIE, Shenzhen (CN)

(21) Appl. No.: 18/206,628

(22) Filed: Jun. 7, 2023

Related U.S. Application Data
(63) Continuation of application No. PCT/CN2021/135488, filed on Dec. 3, 2021.

(30) Foreign Application Priority Data
Dec. 7, 2020 (CN) 202011437147.9
Apr. 9, 2021 (CN) 202110383297.4
Apr. 9, 2021 (CN) 202110384629.0

(51) Int. Cl. A24F 40/485; A24F 40/10; A24F 40/53; A24F 40/46; A24F 40/57

(52) U.S. Cl. CPC A24F 40/485; A24F 40/10; A24F 40/53; A24F 40/46; A24F 40/57

(57) ABSTRACT

An electronic atomization device includes an outlet portion, an adjustment member and a controller. The outlet portion is communicated to an outlet channel through an aerosol channel, and the aerosol channel is divided into a main aerosol channel and an auxiliary aerosol channel between the outlet port of the outlet channel of the atomizer and the outlet portion. The main aerosol channel guides the aerosol generated by the atomizer to reach the outlet portion through the flavour component; and the auxiliary aerosol channel guides the aerosol to reach the outlet portion directly. The adjustment member is received in the aerosol channel for adjusting the amount of aerosol that passes through the auxiliary aerosol channel to reach the outlet portion.

### CROSS REFERENCE

The present application is a continuation-application of International (PCT) Patent Application No. PCT/CN2021/135488, filed on Dec. 3, 2021, which claims priorities of China Patent Application No. 202011437147.9, filed on Dec. 7, 2020, China Patent Application No. 202110383297.4, filed on Apr. 9, 2021, and China Patent Application No. 202110384629.0, filed on Apr. 9, 2021, in the China National Intellectual Property Administration, the entire contents of which are hereby incorporated by reference.

### TECHNICAL FIELD

The present disclosure relates to the field of atomizers, and in particular to an electronic atomization device.

### BACKGROUND

Aerosols generated by burning tobacco contain various carcinogenic substances which are harmful to human health. The aerosols float in the air and may be harmful to surrounding people. Therefore, electronic atomization devices are produced. An electronic atomization device and a regular cigarette have similar appearance and generate similar taste. However, smoke generated by the electronic atomization device does not contain harmful ingredients, such as tar and suspended particles, which may be found in smoke generated by a cigarette. In the market, nicotine satisfaction is core competency of the electronic atomization device. The electronic atomization device in the art generally releases a low level of nicotine, and the nicotine attenuates severely, which does not satisfy a user.

### SUMMARY OF THE DISCLOSURE

In a first aspect, an electronic atomization device is provided and includes a receiving chamber for receiving an atomizer and a flavour component. The atomizer is configured to atomize a matrix to be atomized to produce an aerosol, the atomizer defines an atomization chamber and an outlet channel communicated to the atomization chamber. The aerosol is capable of flowing to an outside through the outlet channel. The flavour component includes a flavour material. The electronic atomization device includes an outlet portion and an adjustment member. The outlet portion is communicated to the outlet channel through an aerosol channel. The aerosol channel is divided into a main aerosol channel and an auxiliary aerosol channel between an outlet port of the outlet channel of the atomizer and the outlet portion, the main aerosol channel is configured to guide the aerosol produced by the atomizer to flow through the flavour component to reach the outlet portion, and the auxiliary aerosol channel is configured to guide the aerosol produced by the atomizer to reach the outlet portion directly. The adjustment member is received in the aerosol channel and configured to adjust an amount of aerosol that flows through the auxiliary aerosol channel to reach the outlet portion.

In a second aspect, an electronic atomization device is provided and includes an atomizer and a flavour component. The atomizer is configured to atomize a matrix to be atomized to produce an aerosol, the atomizer defines an atomization chamber and an outlet port communicated to the atomization chamber, the aerosol is capable of flowing to an outside from the outlet port, the flavour component comprises a flavoring material. The electronic atomizing device includes an outlet portion. The electronic atomizing device defines a first aerosol channel and a second aerosol channel, the first aerosol channel and the second aerosol channel are located between the outlet port of the atomizer and the outlet portion, the aerosol produced by the atomizer is capable of passing through at least one of the first aerosol channel and the second aerosol channel to reach the outlet portion. The electronic atomization device includes a first heating component, configured to heat the flavour component.

### BRIEF DESCRIPTION OF THE DRAWINGS

In order to more clearly describe the technical solutions in the embodiments of the present disclosure, the following will briefly introduce the drawings required in the description of the embodiments. Obviously, the drawings in the following description are only some embodiments of the present disclosure. For those skilled in the art, other drawings can be obtained based on these drawings without creative work.

FIG. 1 is a structural schematic view of an electronic atomization device according to a first embodiment of the present disclosure.

FIG. 2 is a cross sectional view of an atomizer according to the first embodiment of the present disclosure.

FIG. 3 is a schematic view of aerosols flowing in an aerosol channel of an electronic atomization device according to the first embodiment of the present disclosure.

FIG. 4 is a structural schematic view of an enlarged view of a portion of an electronic atomization device according to the first embodiment of the present disclosure.

FIG. 5 is a schematic view of a state change of an adjustment member in an electronic atomization device according to the first embodiment of the present disclosure.

FIG. 6 is a structural schematic view of an electronic atomization device according to a second embodiment of the present disclosure.

FIG. 7 is a schematic view of aerosols flowing in an aerosol channel of an electronic atomization device according to the second embodiment of the present disclosure.

FIG. 8 is a structural schematic view of an electronic atomization device according to a third embodiment of the present disclosure.

FIG. 9 is a schematic view of aerosols flowing in an aerosol channel of an electronic atomization device according to the third embodiment of the present disclosure.

FIG. 10 is a schematic view of a flavour component of the electronic atomization device according to the third embodiment of the present disclosure.

FIG. 11 is a schematic view of aerosols flowing in an aerosol channel of an electronic atomization device according to a fourth embodiment of the present disclosure.

### DETAILED DESCRIPTION

The present disclosure is described in further detail below by referring to the accompanying drawings and embodiments. In particular, the following embodiments are intended to illustrate the present disclosure only, but do not limit the scope of the present disclosure. Similarly, the following embodiments are only some, but not all, embodiments of the present disclosure, and all other embodiments obtained by a person of ordinary skill in the art without creative work shall fall within the scope of the present disclosure.

The terms “first”, “second” and “third” in the present disclosure are descriptive only, and shall not be interpreted as indicating or implying relative importance or implicitly specifying the number of the indicated technical features. Therefore, a feature defined by “first”, “second”, “third” may explicitly or implicitly include at least one such feature. In the description of the present disclosure, “plurality” means at least two, such as two, three, and so on, unless otherwise expressly and specifically limited. All directional indications (such as up, down, left, right, forward, backward, and the like) in embodiments of the present disclosure are used only to explain relative positions of various components, the movement of the various components, and the like, in a particular pose (the pose as shown in the accompanying drawings). If the particular pose changes, the directional indication changes accordingly. The terms “comprising”, “having”, and any variations thereof, in embodiments of the present disclosure are intended to cover non-exclusive inclusion. For example, a process, a method, a system, a product or an apparatus including a series of operations or units is not limited to the listed operations or units, but may also include unlisted operations or units, or may also include other operations or assemblies inherent to the process, the method, the product or the apparatus.

References to “embodiments” mean that a particular feature, a particular structure or a particular property described in the embodiments may be included in at least one embodiment of the present disclosure. The occurrence of the term in various sections in the specification does not necessarily mean one same embodiment, nor is it a separate or alternative embodiment that is mutually exclusive with other embodiments. The ordinary skilled person in the art shall understand both explicitly and implicitly that the embodiments described herein may be combined with other embodiments.

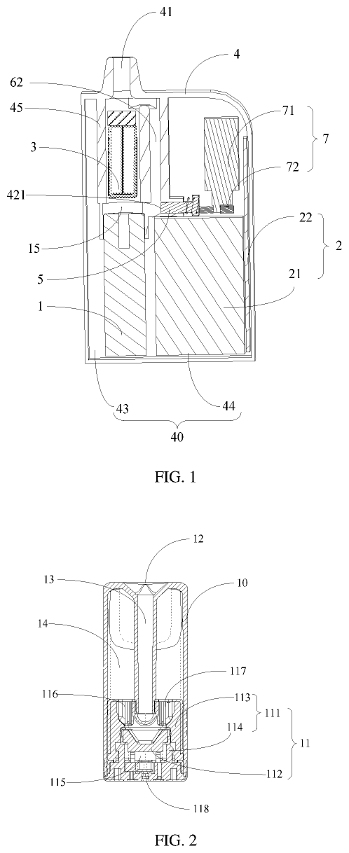

As shown in FIG. 1, FIG. 1 is a structural schematic view of an electronic atomization device according to a first embodiment of the present disclosure.

The electronic atomization device may be configured for atomizing a liquid substrate, such as a nicotine-containing solution and a medicinal liquid. The electronic atomization device includes an atomizer 1, a power supply assembly 2, and a flavour component 3, wherein the atomizer, the power supply assembly, and the flavour component are inter-connected with each other.

The atomizer 1 is configured to store the liquid substrate and to atomize the liquid substrate to generate an aerosol that can be inhaled by a user, such that the atomizer may be applied in various fields, such as applied in a medical field, applied for an electronic aerosolization device, and the like. In an embodiment, the atomizer 1 may be configured in the electronic aerosolization device to atomize an aerosolized substrate to be atomized and generate the aerosols for being inhaled by the user. In the following embodiments, the electronic atomization device may be taken as an example. In other embodiments, the atomizer 1 may also be configured in a hair spray device to atomize a hair spray for hair styling; or in a medical device to atomize a medical substrate for treating upper and lower respiratory tract diseases.

The power supply assembly 2 includes a battery 21, a controller 22 and an airflow sensor. The battery 21 is configured to supply power to the atomizer 1 to enable the atomizer 1 to atomize the liquid substrate to form the aerosols. The controller 22 is configured to control the atomizer 1 to operate. The airflow sensor is configured to detect a change in an airflow in the electronic atomization device to activate the electronic atomization device.

The atomizer 1, the power supply assembly 2 and the flavour component 3 may be configured as one integral and overall component, or may be detachably connected with each other, which may be determined based on the actual demands. Arrangement of the atomizer 1, the power supply assembly 2 and the flavour component 3 is not limited by the present disclosure. For example, the atomizer 1 and the flavour component 3 may be arranged coaxially, the atomizer 1 and the power supply assembly 2 may be arranged side-by-side; or the atomizer 1, the power supply assembly 2 and the flavour component 3 may be arranged side-by-side.

The flavour component 3 includes a flavour material. The flavour material includes one or more volatile flavour substances. The flavour substances include one or more of tobacco spice, menthol, wintergreen, peppermint, herbal spice, fruit spice, nut spice, and wine spice. The user may select the flavour material based on his or her preference. Currently, the flavour material that accounts for a largest proportion in the market is nicotine flavour, such that the user may feel like taking a real cigarette while inhaling the smoke generated by the electronic atomization device, improving user satisfaction. For example, the flavour component 3 may be a flavour bomb as commonly named; alternatively, the flavour component 3 may be a heated non-combustible cigarette. In the present embodiment, the flavour component 3 may be the flavour bomb as commonly named.

As shown in FIG. 2, FIG. 2 is a cross sectional view of an atomizer according to the first embodiment of the present disclosure.

The atomizer 1 includes a housing 10 and an atomizer 11. The atomizer 11 includes an atomization seat 111 and an atomization core 112. The atomization seat 111 is arranged on the housing 10. The atomization core 112 is mounted on the atomization seat 111.

The housing 10 defines an outlet channel 13 and a liquid storage space 14. The liquid storage space 14 surrounds the outlet channel 13. An end of the housing 10 defines an outlet port 12 of the outlet channel 13. The liquid storage space 14 is defined to store the liquid substrate. A wall of the liquid storage space 14 may be made of metal, such as aluminum and stainless steel, or plastic, as long as the liquid storage space 14 is able to store the liquid substrate to be atomized, and the wall of the liquid storage space 14 does not react with the liquid substrate to change the nature of the liquid substrate. A shape and a size of the liquid storage space 14 is not limited by the present disclosure, and can be determined as required.

The atomization seat 111 is disposed on a side of the liquid storage space 14 away from the outlet port 12. In detail, the housing 10 defines a receiving slot on the side of the liquid storage space 14 away from the outlet port 12, and the atomization seat 111 is received in the receiving slot. The atomization seat 111 includes an atomization top seat 113 and an atomization bottom seat 114. The atomization top seat 113 and the atomization bottom seat 114 may be connected to each other by a buckling-engagement structure. For example, a protrusion may be arranged on the atomization top seat 113, and a slot may be defined in the atomization bottom seat 114. Alternatively, a protrusion may be arranged on the atomization bottom seat 114, and a slot may be defined in the atomization top seat 113. The atomization seat 111 may be made of ceramic, stainless steel or other alloys, as long as the atomization seat 11 is able to support other components. A shape and a size of the atomization seat 111 is not limited by the present disclosure, and may be determined as required.

An atomization cavity 115 is defined between the atomization top seat 113 and the atomization bottom seat 114. In detail, the atomization cavity 115 is defined between an atomization surface of the atomization core 112 and the atomization bottom seat 114. The atomization cavity 115 is communicated to the outlet channel 13. Two ends of the atomization core 112 are lapped to the atomization seat 111. A middle portion of the atomization core 112 is suspended in the atomization cavity 115. The atomization core 112 is at least partially received in the atomization top seat 113. The atomization top seat 113 is disposed between the liquid storage space 14 and the atomization core 112. The atomization top seat 113 defines a first downflow channel 116 and a second downflow channel 117. An end of the first downflow channel 116 and an end of the second downflow channel 117 are communicated to the liquid storage space 14. The other end of the first downflow channel 116 and the other end of the second downflow channel 117 are connected to the atomization core 112. In this way, the liquid substrate to be atomized in the liquid storage space 14 are guided to the atomization core 112 through the first downflow channel 116 and the second downflow channel 117. The atomization bottom seat 114 defines an inlet channel 118. The inlet channel 118 is communicated to the atomization cavity 115, such that the inlet channel 118 is communicated to the atomization cavity 115 and an outside of the electronic atomization device. The inlet channel 118, the atomization cavity 115, and the outlet channel 13 cooperatively serve as an airflow channel of the atomizer 1.

The atomization core 112 includes a heating member and a porous member. The liquid substrate in the liquid storage space 14 enters the atomization core 112 through the first downflow channel 116 and the second downflow channel 117. The porous member takes a capillary force to guide the liquid substrate to be atomized to an atomization surface of the heating member. The heating member is configured to heat and atomize the liquid substrate. The porous member may be a cotton wick or ceramic, which may be determined based on demands.

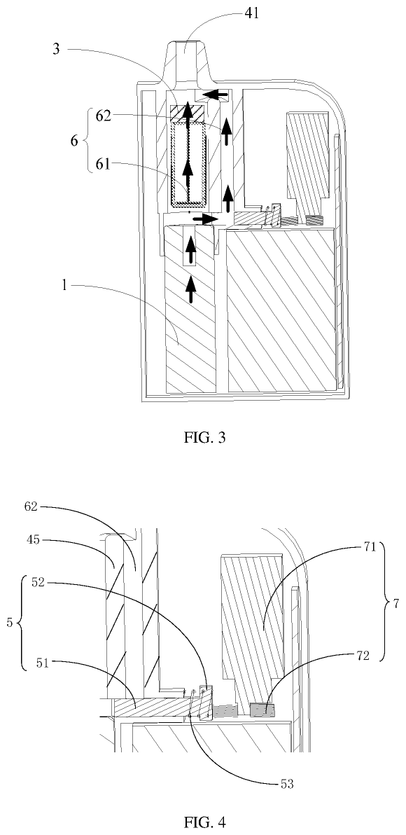

FIG. 3 is a schematic view of aerosols flowing in an aerosol channel of an electronic atomization device according to the first embodiment of the present disclosure.

Further as shown in FIG. 1 and FIG. 3, the electronic atomization device further includes a housing 4, an adjustment member 5, an aerosol channel 6 and a drive assembly 7. The housing 4 defines a housing cavity 40. The atomizer 1, the power supply assembly 2, the flavour component 3, the adjustment member 5, the aerosol channel 6 and the drive assembly 7 are received in the housing cavity 40. An end of the housing 4 forms the outlet portion 41 for the user to inhale the atomized aerosols.

The aerosol channel 6 is communicated to the atomization cavity 115 of the atomizer 1 and the outlet portion 41. The aerosol channel 6 diverges into a main aerosol channel 61 and an auxiliary aerosol channel 62 at the outlet port 12 of the outlet channel 13 of the atomizer 1. That is, the aerosol channel 6 includes a first aerosol channel 61 and a second aerosol channel 62. The first aerosol channel 61 and the second aerosol channel 62 are located between the outlet port 12 and the outlet portion 41 of the atomizer 1. The aerosol generated by the atomizer 1 is guided to the outlet portion 41 via at least one of the first aerosol channel 61 and the second aerosol channel 62.

Further, the flavour material is received in the first aerosol channel 61. In the preset embodiment, the flavour component 3 is received in the first aerosol channel 61. The first aerosol channel guides the aerosol generated by the atomizer 1 to pass through the flavour component 3 to reach the outlet portion 41. The second aerosol channel 62 guides the aerosol generated by the atomizer 1 to reach the outlet portion 41 directly. It shall be understood that the aerosol channel 6 may diverge into the first aerosol channel 61 and the second aerosol channel 62 at the outlet port of the atomizer 1. Alternatively, the aerosol channel 6 may diverge into the first aerosol channel 61 and the second aerosol channel 62 at a position at a certain distance from the outlet port of the atomizer 1. A value of the distance may be determined based on demands. A divergence point of the aerosol channel 6 may be determined based on demands, and shall not be limited by the present disclosure.

An aerosol mixing zone is formed between an end of the flavour component 3 near the outlet portion 41 and the outlet portion 41. The aerosol in the first aerosol channel 61 and the aerosol in the second aerosol channel 62 are mixed in the aerosol mixing zone and enter the outlet part 41 subsequently. That is, the aerosol in the first aerosol channel 61 and the aerosol in the second aerosol channel 62 are mixed outside the flavour component 3, enter the outlet portion 41 after being mixed, and are inhaled by the user.

Further as shown in FIG. 1, in detail, the housing cavity 40 defined by the housing 4 includes an atomizer mounting cavity 43 and a body mounting cavity 44. A cavity wall is arranged serving as a cavity wall of the atomizer mounting cavity 43 and a cavity wall of the body mounting cavity 44 at the same time. The flavour component 3 and the atomizer 1 are received in the atomizer mounting cavity 43. That is, the electronic atomization device has a cavity for receiving the atomizer 1 and the flavour component 3, and the cavity is the atomizer mounting cavity 43. The atomizer 1 and the flavour component 3 are coaxial. The outlet portion 41 is disposed at an end of the flavour component 3 away from the atomizer 1. The power supply assembly 2 and the drive assembly 7 are received in the body mounting cavity 44. That is, the drive assembly 7, the battery 21 and the controller 22 are received in the body mounting cavity 44. The atomizer 1 and the flavour component 3 are separated from the battery 21, the controller 22 and the drive assembly 7 by the cavity wall of the atomizer mounting cavity 43 and the body mounting cavity 44. In this way, the aerosols, which is generated by the atomizer 1 atomizing the liquid substrate to be atomized, may be prevented from entering the body mounting cavity 44, such that the aerosols, after being condensed, may be prevented from affecting the drive assembly 7, the battery 21 and the controller 22. It shall be understood that the cavity wall of the atomizer mounting cavity 43 and the body mounting cavity 44 does not need to separate the atomizer 1 and the flavour component 3 completely away from the battery 21, the controller 22 and the drive assembly 7, as long as the aerosol channel 6 is completely isolated from the battery 21, the controller 22 and the drive assembly 7.

The electronic atomization device further includes a bracket 45 received in the atomizer mounting cavity 43. A cavity defined by the bracket 45 may receive the flavour component 3.

The second aerosol channel 62 is defined between the bracket 45 and the cavity wall of the atomizer mounting cavity 43. That is, the second aerosol channel 62 is defined between the cavity wall of the atomizer mounting cavity 43 and a side wall of the flavour component 3. The second aerosol channel is defined inside the atomizer mounting cavity 43. An extension direction of the second aerosol channel 62 is parallel to an extension direction of the flavour component 3, and the second aerosol channel 62 is defined at a side of the flavour component 3. An end of the second aerosol channel 62 near the atomizer 1 serves as an inlet port, and an end of the second aerosol channel 62 near the outlet portion serves as an outlet port.

In an embodiment, the outlet port 12 of the outlet channel 13 of the atomizer 1 directly faces the flavour component 3, and the aerosols generated by being atomized by the atomizer 1 directly enters the flavour component 3. A gap 15 is defined between the atomizer 1 and the flavour component 3, and the second aerosol channel 62 is defined on a side of the flavour component 3. That is, the second aerosol channel 62 is misaligned with the outlet port 12 of the outlet channel 13 of the atomizer 1, the second aerosol channel 62 is communicated to the outlet channel 13 through the gap 15, and the second aerosol channel 62 extends towards the outlet portion 41. Specifically, the second aerosol channel 62 may extend towards the outlet portion 41 linearly. Alternatively, the second aerosol channel 62 may extend towards the outlet portion 41 in a curved or a spiral manner, as long as the second aerosol channel 62 extends to reach the outlet portion 41. In the present embodiment, the second aerosol channel 62 extends towards the outlet portion 41 linearly, and an opening direction of the inlet port of the second aerosol channel 62 is the same as a length direction of the flavour component 3, and faces towards a side of the atomizer 1.

The adjustment member 5 is configured to adjust an amount of aerosols, which flow through the second aerosol channel 62 to reach the outlet portion 41. Adjusting an amount of aerosols, which flows through the auxiliary aerosol channel 62 to reach the outlet portion 41, may be achieved by adjusting a size of the inlet port of the second aerosol channel 62, adjusting a size of the outlet port of the auxiliary second channel 62, or adjusting a size of the airflow channel in a middle of the second aerosol channel 62. That is, the adjustment member 5 may be disposed at the inlet port of the second aerosol channel 62 to adjust the amount of aerosols entering the second aerosol channel 62 to further adjust the amount of aerosols, which flow through the second aerosol channel 62 to reach the outlet portion 41. Alternatively, the adjustment member 5 may be disposed at the outlet port of the second aerosol channel to adjust the amount of aerosols, which flow through the second aerosol channel 62 to reach the outlet portion 41. Alternatively, the adjustment member 5 may be disposed in the middle of the second aerosol channel 62 to adjust the amount of aerosols, which flow through the second aerosol channel 62 to reach the outlet portion 41. A specific manner of which the adjustment member 5 is disposed is determined based on actual demands. In the present embodiment, the adjustment member 5 adjusts the amount of aerosols, which flow through the second aerosol channel 62 to reach the outlet portion 41, by adjusting the amount of aerosols at the inlet port of the second aerosol channel 62. Engagement between the adjustment member 5 and other structures will be described below. When the adjustment member 5 is disposed at the outlet port of the second aerosol channel 62 or in the middle of the second aerosol channel 62, the engagement between the adjustment member 5 and the other structures will have to be changed accordingly.

The cavity wall of the atomizer mounting cavity 43 defines a through hole 421 below a plane where the inlet port of the auxiliary aerosol channel 62 is defined. That is, an extension direction of the through hole 421 is perpendicular to a direction to which the inlet port of the auxiliary aerosol channel 62 faces. The through hole 421 is communicated to the atomizer mounting cavity 43 and the body mounting cavity 44. A part of the adjustment member 5 is received in the through hole 421, and another part of the adjustment member 5 is received in the body mounting cavity 44. A part of the adjustment member 5 is received in the through hole 421, and a size of the part of the adjustment member 5 is adapted to a size of the through hole 421, such that the atomizer mounting cavity 43 is isolated from the body mounting cavity 44, preventing the aerosols atomized by the atomizer 1 in the atomizer mounting cavity 43 from entering the body mounting cavity 44. As the extension direction of the through hole 421 is perpendicular to the direction to which the inlet port of the second aerosol channel 62 faces, the adjustment member 5 moves along the through hole 421 to approach the atomizer mounting cavity 43. That is, a moving direction of the adjustment member 5 is perpendicular to the direction to which the inlet port of the second aerosol channel 62 faces, such that the adjustment member 5 may cover the inlet port of the second aerosol channel 62. In this way, the size of the inlet port of the second aerosol channel 62 may be changed, such that the amount of the aerosols, which is atomized by the atomizer 1 and flows through the second aerosol channel 62 to enter the outlet portion 41, may be adjusted. In an embodiment, a height of the through hole 421 is equal to a height of the gap 15 between the atomizer 1 and the flavour component 3, such that the adjustment member 5 may be partially received in the gap 15 between the atomizer 1 and the flavour component 3, and therefore, the inlet port of the second aerosol channel 62 may be covered more reliably.

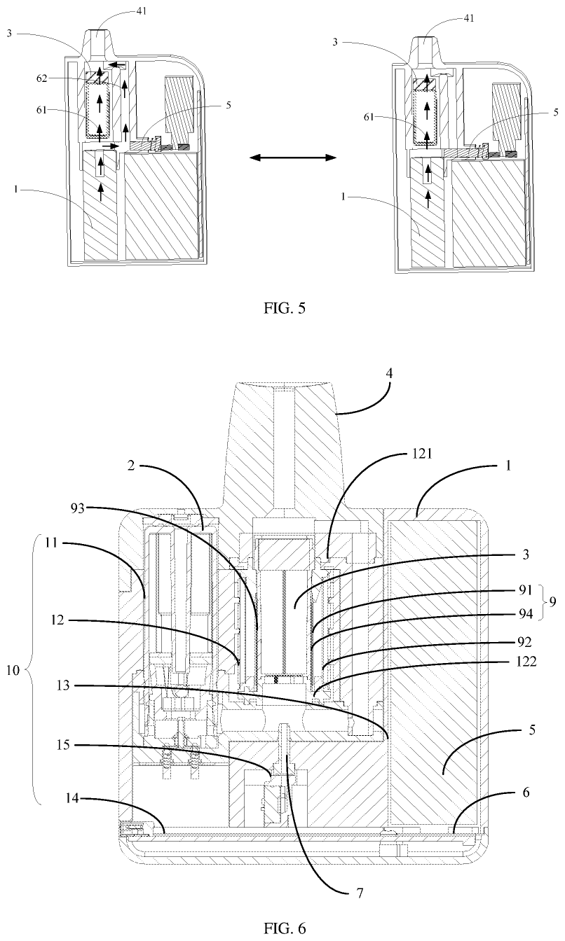

As shown in FIG. 4, FIG. 4 is a structural schematic view of an enlarged view of a portion of an electronic atomization device according to the first embodiment of the present disclosure.

The adjustment member 5 includes a moving portion 51 and an engaging portion 52. The moving portion 51 and the engaging portion 52 are fixedly connected. The moving portion 51 and the engaging portion 52 may be fixedly connected by a screw, by adhering, by a buckle, and the like. Alternatively, the moving portion 51 and the engaging portion 52 may be one integral and overall structure. A part of the moving portion 51 is received in the through hole 421, and another part of the moving portion 51 is received in the body mounting cavity 44. A cross section of the moving portion 51 may be rectangular, circular or in other shapes, which may be determined based on demands, as long as the adjustment member 5 blocks the through hole 421, preventing the aerosol from entering the body mounting cavity 44. In the present embodiment, the cross section of the moving portion 51 is rectangular. The engaging portion 52 is received in the body mounting cavity 44. The engaging portion 52 is configured to connect the drive assembly 7. The drive assembly 7 provides a driving force to move the adjustment member 5. A size of the engaging portion 52 is greater than a size of the moving portion 51. The engaging portion 52 is engaged to a cavity wall of the body mounting cavity 44 near the through hole 421. In another embodiment, an end of the engaging portion 52 extends to an outside of the housing 4. The user may push or pull the engaging portion 52 to move the adjustment member 5 to approach or to be away from the flavour component 3, such that the amount of aerosols, which flow through the second aerosol channel 62 to reach the outlet portion 41, is adjusted.

In the present embodiment, the adjustment member 5 is moved by the driving force provided by the drive assembly 7. The controller 22 is further configured to control the drive assembly 7 to operate. That is, the controller 22 controls the drive assembly 7 to operate, and the drive assembly 7 provides the driving force to move the adjustment member 5, such that the amount of aerosols, which flow through the second aerosol channel 62 to reach the outlet portion 41, is adjusted.

The drive assembly 7 includes a motor 71 and a rotation table 72. The rotation table 72 is connected to the motor 71, and the adjustment member 5 is connected to the rotation table 72. The motor provides a driving force to move the rotation table 72. The rotation table 72 drives the adjustment member 5 to move. In this way, the adjustment member 5 gradually blocks the inlet port of the second aerosol channel 62 to adjust the amount of aerosols, which flow through the second aerosol channel 62 to reach the outlet portion 41.

In the present embodiment, the adjustment member 5 further includes an elastic member 53. The elastic member 53 is configured to return the adjustment member 5 to an initial position when the motor 71 stops applying the driving force. In an embodiment, the elastic member 53 is a spring. The spring sleeves the moving portion 51. An end of the spring is fixed to the engaging portion 52, and the other end of the spring is fixed to a side of a cavity wall of the body mounting cavity 44 near the drive assembly 7. The present disclosure does not limit a potion at which the spring is disposed or a manner of fixing the spring, as long as a force is applied to move the adjustment member 5 to the initial position.

In other embodiments, the elastic member 53 may be an element, such as an elastic sheet, a rubber band, or the like, which has elasticity and may be restored to its original state. The elastic member may be determined based on demands. The other end of the elastic member 53 may not be fixed, but simply abut against the cavity wall of the body mounting cavity 44 near the end of the through hole 421 near the drive assembly 7. A size of the elastic member 53 is greater than the size of the through hole 421, and the elastic member 53 may not be received in the through hole 421 as the moving portion 51 moves. Alternatively, the other end of the elastic member 53 may be fixed to the housing 4, and an extension direction of the elastic member 53 is the same as the extension direction of the adjustment member 5. Connection between the elastic member 53 and other structures may be determined based on demands.

In another embodiment, the elastic member 53 may not need to be configured on the adjustment member 5. The adjustment member 5 is driven by the drive assembly 7 to gradually block the inlet port of the second aerosol channel 62. That is, the drive assembly 7 drives the adjustment member 5 to move to approach the flavour component 3, and in this case, the motor 71 rotates in a first direction. After the inlet port of the second aerosol channel 62 is completely blocked by the adjustment member 5, when the inlet port needs to be unblocked, the driving force is applied by the drive assembly 7 to gradually unblock the inlet port of the second aerosol channel 62. That is, the drive assembly 7 drives the adjustment member 5 to move away from the flavour component 3, and in this case, the motor 71 rotates in a second direction. The second direction is opposite to the first direction.

The electronic atomization device further includes a memory (not shown), which stores parameter information. The parameter information includes a predetermined inhalable value of the flavour component 3 and a concentration of the flavour material corresponding to the number of inhalation times. The memory transmits the parameter information to the controller 22. The controller 22 compares the number of inhalation times detected by the airflow sensor to the parameter information, and controls a current output to the drive assembly 7 to further control the driving force applied by the drive assembly 7 to the adjustment member 5, such that a speed that the adjustment member 5 moves to approach the flavour component 3 is adjusted. In this way, the size of the inlet port of the second aerosol channel 62 is adjusted, such that the amount of the aerosols that flows through the second aerosol channel to reach the outlet portion 41 is adjusted, and the concentration of the flavour material in an inhalation process is adjusted, enabling the concentration of the flavour material in the inhalation process to be uniform.

As shown in FIG. 5, FIG. 5 is a schematic view of a state change of an adjustment member in an electronic atomization device according to the first embodiment of the present disclosure.

At an initial stage of operation (the flavour component 3 is not inhaled), the inlet port of second aerosol channel 62 is completely unblocked. That is, the inlet port of second aerosol channel 62 is not blocked by the adjustment member 5 at all. As the atomizer 1 operates, the flavour released from the flavour material of the flavour component 3 gradually attenuates, a voltage output by the controller 22 to control the drive assembly 7 gradually increases, the driving force applied by the drive assembly 7 to the adjustment member 5 gradually increases, the speed that the adjustment member 5 moves to approach the flavour component 3 gradually increases, and the adjustment member 5 blocks the inlet port of the second aerosol channel 62. In this way, the inlet port gradually decreases and is completely blocked eventually, the amount of the aerosols, which is atomized by the atomizer 1 and flows through the second aerosol channel 62 to reach the outlet portion 41, gradually decreases, and at the same time, the amount of the aerosols, which is atomized by the atomizer 1 and flows through the flavour component 3 to reach the outlet portion 41, gradually increases. In this way, the concentration of the flavour material in the inhalation process is almost uniform, solving the problem of the flavour released from the flavour material being attenuated.

According to the first embodiment, the electronic atomization device includes the outlet portion 41, the adjustment member 5 and the controller 22. The electronic atomization device further defines the receiving chamber. The receiving chamber receives the atomizer 1 and the flavour component 3. The flavour component 3 includes the flavour material, which is capable of releasing flavour. The outlet portion 41 is communicated to the outlet channel 13 through the aerosol channel 6. The aerosol channel 6 is divided into the first aerosol channel 61 and the second aerosol channel 62 between the outlet port 12 of the outlet channel 13 of the atomizer 1 and the outlet portion 41. The first aerosol channel 61 enables the aerosol generated by the atomizer 1 to flow through the flavour component 3 to carry the flavour of the flavour material in the flavour component 3 to reach the outlet portion 41. The second aerosol channel 62 enables the aerosol generated by the atomizer 1 to reach the outlet portion 41 directly. The adjustment member 5 may change the amount of the aerosol that flows through the second aerosol channel 62 to reach the outlet portion 41. By defining the second aerosol channel 62, and by configuring the adjustment member 5 to adjust the amount of aerosol that flows through the second aerosol channel to reach the outlet portion 41, aerosol diversion may be dynamically controlled. In this way, the flavour of the flavour material may be inhaled by the user in a smooth and uniform manner, the user may obtain a higher extent of satisfaction. The problem of the flavour released from the flavour material in the flavour component being attenuated may be avoided, enhancing competitiveness of the product and creating economic benefits.

It shall be understood that, the atomizer 1 and the flavour component 3 may be disposed side-by-side. Arrangement of the outlet port 12 of the atomizer 1, the adjustment member 5 and the driving assembly 7 may be changed accordingly to allow the adjustment member 5 to adjust the amount of aerosol that flows through the second aerosol channel 62 to reach the outlet portion 41, achieving dynamic control of the aerosol diversion, and enabling the flavour of the flavour material inhaled by the user to be smooth and uniform. Detailed structure of the atomizer 1 and the flavour component 3 and arrangement of the first aerosol channel 61 and the second aerosol channel 62 may be referred to the second embodiment of the electronic atomization device.

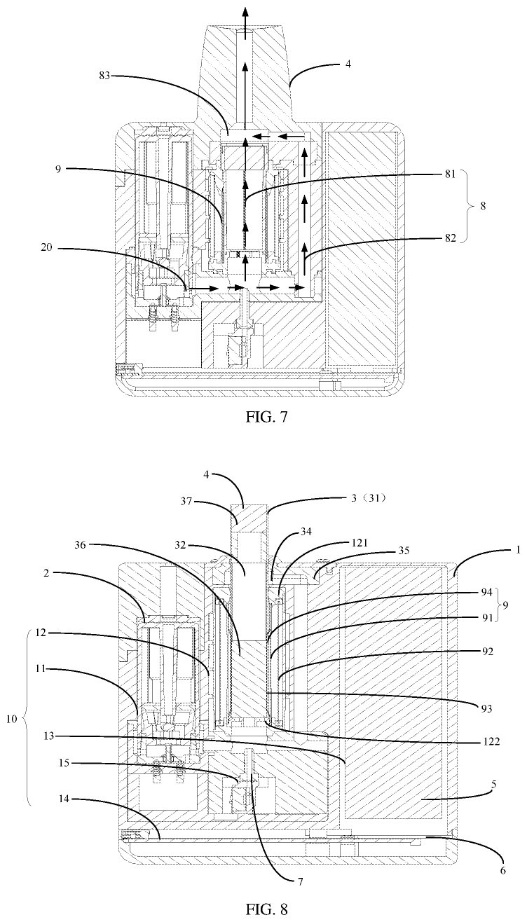

As shown in FIG. 6 and FIG. 7, FIG. 6 is a structural schematic view of an electronic atomization device according to a second embodiment of the present disclosure, and FIG. 7 is a schematic view of aerosols flowing in an aerosol channel of an electronic atomization device according to the second embodiment of the present disclosure.

In the second embodiment, it is the same as the first embodiment in that divergence into the first aerosol channel and the second aerosol channel occurs between the outlet port of the outlet channel of the atomizer and the outlet portion. A difference between the second embodiment and the first embodiment includes the arrangement of the atomizer and the flavour component, a location wherein the outlet port of the atomizer is defined, and a way of adjusting the concentration of the flavour material in the aerosol at the outlet portion.

The electronic atomization device includes a housing 1, an atomizer 2, a flavour component 3, an outlet portion 4, a battery 5, a controller 6, and an airflow sensor 7. In the present embodiment, the flavour component 3 is the flavour bomb as commonly named.

The housing 1 defines a receiving cavity 10. The atomizer 2, the flavour component 3, the battery 5, the controller 6 and the airflow sensor 7 are received in the receiving cavity 10 of the housing 1. The atomizer 2 is configured to atomize a matrix to be atomized to produce an aerosol. The atomizer 2 defines an atomization chamber (not shown) and an outlet port 20 communicated to the atomization chamber. Atomized aerosol of the atomizer 2 flows out through the outlet port 20. The flavour component includes a flavour material. Alternatively, the flavour material includes a nicotine flavour. The atomizer 2, the battery 5 and the airflow sensor 7 are electrically connected to the controller 6. The controller 6 controls the battery 5 to output an operating voltage to the atomizer 2 based on detection information of the airflow sensor 7 to allow the atomizer 2 to work. The user inhales the aerosol through the outlet portion 4. The outlet portion 4 and the housing 1 may be integrally formed or may be separated components fixedly connected by adhesion and the like.

In detail, the receiving chamber defined by the housing 1 includes an atomizer mounting cavity 11, a flavour component mounting cavity 12, a battery mounting cavity 13, a controller mounting cavity and an airflow sensor mounting cavity 15. The atomizer 2 is received in the atomizer mounting cavity 11, the flavour component 3 is received in the flavour component mounting cavity 12, the battery 5 is received in the battery mounting cavity 13, the controller 6 is received in the controller mounting cavity 14, and airflow sensor 7 is received in the airflow sensor mounting cavity 15.

In the present embodiment, the atomizer 2, the flavour component 3 and the battery 5 are disposed side-by-side. That is, the atomization mounting cavity 11, the flavour component mounting cavity 12 and the battery mounting cavity 13 are defined side-by-side. The outlet portion 4 is disposed directly above the flavour component 3, and the airflow sensor 7 is disposed directly below the flavour component 3. That is, the airflow sensor mounting cavity 15 is defined directly below the flavour component mounting cavity 12. It shall be understood that, the location wherein the airflow sensor 7 is disposed may be determined based on demands, as long as the airflow sensor 7 is able to sense changes in an airflow during the inhalation process. The controller 6 is disposed on a side of the airflow sensor 7 away from the flavour component 3, and disposed on a side of the atomizer 2 and the battery 5 away from the outlet portion 4. That is, the controller mounting cavity 14 is defined on a side of the atomizer mounting cavity 11, the airflow sensor mounting cavity 15 and the battery mounting cavity 13 away from the outlet portion 4.

The outlet portion 4 is communicated to the outlet port 20 through an aerosol channel 8. The aerosol channel 8 diverges into a first aerosol channel 81 and a second aerosol channel 82 at a position between the outlet port 20 and the outlet portion 4. In other words, the aerosol channel 8 includes the first aerosol channel 81 and the second aerosol channel 82. The first aerosol channel 81 and the second aerosol channel 82 are located between the outlet port 20 of the atomizer 2 and the outlet portion 4. The aerosol produced by the atomizer 2 passes through at least one of the first aerosol channel 81 and the second aerosol channel 82 to reach the outlet portion 4.

Further, the flavour material is arranged in the first aerosol channel 81. In the present embodiment, the flavour component 3 is received in the first aerosol channel 81. The first aerosol channel allows the aerosol produced by the atomizer 2 to flow through the flavour component 3 to reach the outlet portion 4. The second aerosol channel 82 allows the aerosol produced by the atomizer 2 to reach the outlet portion 4 directly. In other words, after the aerosol atomized by the atomizer 2 flows out through the outlet port 20, a part of the aerosol flows through the flavour material of the flavour component 3 to reach the outlet portion 4, and another part of the aerosol reaches the outlet portion 4 directly without passing through the flavour component 3.

In the present embodiment, the atomizer 2, the flavour component 3 and the second aerosol channel 82 are disposed side-by-side, and the second aerosol channel 82 is defined on the side of the flavour component 3 away from the atomizer 2. In an embodiment, a cavity wall of the flavour component mounting cavity 12 is spaced from a cavity wall of the battery mounting cavity 13, i.e. a gap is present between the cavity wall of the flavour component mounting cavity 12 and the cavity wall of the battery mounting cavity 13. The gap between the cavity wall of the flavour component mounting cavity and the cavity wall of the battery mounting cavity 13 serves as the second aerosol channel 82. An end of the second aerosol channel 82 is communicated to the outlet port 20 of the atomizer 2, and the other end of the second aerosol channel 82 is communicated to the atomizer 2. In another embodiment, a part of the cavity wall of the flavour component mounting cavity 12 serves as a part the cavity wall of the battery mounting cavity 13. The cavity wall shared by the flavour component mounting cavity 12 and the battery mounting cavity 13 defines a through hole along a length direction of the electronic atomization device, and the through hole serves as the second aerosol channel 82. An end of the second aerosol channel 82 is communicated to the outlet port 20 of the atomizer 2, and the other end is communicated to the outlet portion 4. Arrangement of the second aerosol channel 82 may be determined based on the needs of application, and shall not be limited by the present disclosure.

In an embodiment, a structure of the atomizer 2 of the second embodiment may be identical to that of the atomizer of the first embodiment, that is, the outlet port 20 of the atomizer 2 is located at the end of the atomizer 2 near the outlet portion 4 and at a top of the atomizer 2. Since air inlets of the first aerosol channel 81 and the second aerosol channel 82 are located at an end away from the outlet portion 4, in order to allow the outlet port 20 of the atomizer 2 to communicate with the air inlets of the first aerosol channel 81 and the second aerosol channel 82, a gap is present between an outer surface of the atomizer 2 and an inner surface of the atomizer mounting cavity 11 to serve as an air channel to allow the atomized aerosol of the atomizer 2 to enter the aerosol channel 8.

In another embodiment, a structure of the atomizer 2 of the second embodiment is substantially the same as that of the atomizer of the first embodiment. A difference there between refers to a location at which the outlet port 20 of the atomizer 2 is defined and a location at which the air inlet of the atomizer tis defined. In the present embodiment, the outlet port 20 of the atomizer 2 is defined at an end of a side wall of the atomizer 2 away from the outlet portion 4, and the air inlet of the atomizer 2 is defined at an end of the atomizer 2 near the outlet portion 4 and at the top of the atomizer 2.

It shall be understood that, the air inlet of the atomizer 2 defined in the second embodiment may be the same as that defined in the first embodiment, and the outlet port 20 is defined at the end of the side wall of the atomizer 2 away from the outlet portion 4, such that a space for defining the outlet channel in the first embodiment may be reduced, and a space of the liquid storage cavity may be increased. In this way, a storage volume of the matrix to be atomized may be increased. Defining the air inlet of the atomizer 2 of the second embodiment may be determined based on demands, and shall not be limited by the present disclosure.

As the air inlets of the first aerosol channel 81 and the second aerosol channel 82 are located at the end away from the outlet portion 4, defining the outlet port 20 of the atomizer 2 at the end of the side wall of the atomizer 2 away from the outlet portion 4 may shorten a path of the atomized aerosol of the atomizer 2 flowing into the first aerosol channel 81 and the second aerosol channel 82, reduce generation of condensate, and increase the amount of aerosol at the outlet portion 4. The user's experience may be improved.

Further, an aerosol mixing zone 83 is defined between the end of the flavour component 3 near the outlet portion 4 and the outlet portion 4, and the aerosol in the first aerosol channel 81 and the aerosol in the second aerosol channel 82 are mixed in the aerosol mixing zone 83 and enter the outlet portion 4 subsequently. That is, the aerosol in the first aerosol channel 81 and the aerosol in the second aerosol channel 82 are mixed outside the flavour component 3, enter the outlet portion 4 after being mixed, and inhaled by the user.

The electronic atomization device further includes a first heating member 9. The first heating member 9 is configured to heat the flavour component 3 to adjust the flavour concentration of the flavour material in the aerosol at the outlet portion 4. The first heating member 9 is electrically connected to the controller 6. The first heating member 9 is received in the flavour component mounting cavity 12 defined in the housing 1. Further, the first heating member 9 defines a receiving cavity 93 for receiving the flavour component 3.

In the present embodiment, the first heating component 9 includes a metal tube 94 and a heating member 91. The metal tube 94 defines the receiving cavity 93. It shall be understood that, an inner space of the metal tube 94 serves as the receiving cavity 93, and the flavour component 3 is received in the inner space of the metal tube 94. The heating member 91 surrounds an outer surface of the metal tube 94 and is configured to heat the flavour component 3 to regulate an amount of the flavour released from the flavour material. The heating member 91 is one of a flexible circuit board, a thick film and a metal heating sheet. In order to increase a heating efficiency of the heating member 91, the heating member 91 adheres to the outer surface of the metal tube 94.

In detail, the heating member 91 may be in the form of a sheet. The electronic atomization device may include a plurality of heating members 91. The plurality of heating members 91 surrounds a periphery of the flavour component 3, and are spaced apart from each other. A spacing distance between the plurality of heating members 91 may be determined based on heating efficiencies of the heating members 91. At least part of the flavour component 3 (a part of the flavour component 3 having the flavour material) is received in the cavity formed by the plurality of heating members 91. That is to say, the part of the flavour component 3 having flavour material is received in the cavity formed by the plurality of heating members 91. A part of the flavour component 3 not having the flavour material may be received in or disposed out of the cavity formed by the plurality of heating members 91.

The heating member 91 may be in the form of a ring, disposed around a circumference of the flavour component 3. In an embodiment, the electronic atomization device includes a plurality of heating members 91, each of plurality of heating members 91 is disposed around the circumference of the flavour component 3, and the plurality of heating members 91 are spaced apart from each other along a length direction of the flavour component 3. A spacing distance may be determined based on the heating efficiency of the heating component 9. The part of the flavour component 3 having flavour material is received in a cavity defined by the plurality of heating members 91 cooperatively. The part of the flavour component 3 not having the flavour material may be received in or disposed out of the cavity defined by the plurality of heating members 91 cooperatively. In another embodiment, the electronic atomization device includes one heating member 91, disposed around the circumference of the flavour component 3. The part of the flavour component 3 having flavour material is received in a cavity defined by the heating member 91. The part of the flavour component 3 not having the flavour material may be received in or disposed out of the cavity defined by the heating member 91.

The electronic atomization device further includes a heat insulator 92, received in the flavour component mounting cavity 12 and is located on a side of the first heating component 9 away from the flavour component 3. The heat insulator 92 is spaced apart from the first heating component 9 to create air insulation between the heat insulator 91 and the first heating component 9, reducing a heat loss of the heating member 91 in the first heating component 9 and improving the heating efficiency of the heating member 91.

In order to achieve a better heat insulation effect, the heat insulator 92 is ring shaped and is an overall and integral structure. The first heating component 9 is completely received in the cavity defined by the heat insulator 92. Structures of the first heating component 9 and the heat insulator 92 shall be determined based on demands, as long as the first heating component 9 is able to heat the flavour material in the flavour component 3, and the heat insulator 92 is able to achieve heat insulation. It shall be understood that the heat insulator 92 is an optional structure.

It shall be understood that the first heating component 9 and the flavour component 3 both are received in the flavour component mounting cavity 12. A fixing mechanism 121 is arranged on a cavity wall of the flavour component mounting cavity 12 to fix the first heating component 9 and the heat insulator 92. A fixing seat 122 is received in the flavour component mounting cavity 12. The flavour component 3 is received in the receiving cavity 93 defined by the metal tube 94 of the first heating component 9. The flavour component 3 is fixed by the fixing seat 122. The first heating component 9 and the heat insulator 92 are fixed by the fixing seat 122. That is, an end of the flavour component 3 is fixed by the fixing seat 122; an end of the first heating component 9 and the heat insulator 92 are fixed to the fixing mechanism 121, and the other end is fixed to the fixing seat 122.

The controller 6 is electrically connected to the heating member 91 of the first heating component 9. The controller 6 controls a heating temperature of the heating member 91 of the first heating component 9 based on the number of inhalations detected by the airflow sensor 7, to further regulate the amount of flavour released by the flavour material, such that a flavour concentration of the flavour material in the aerosol at the outlet portion 4 remains uniform as the atomizer 1 continuously operates.

It shall be understood that at different temperatures, the amount of flavour released from the flavour material in the flavour component 3 varies. The higher the temperature is, the more the flavour released of the flavour material in the flavour component 3. As inhalation continues, the flavour of the flavour material in the flavour component 3 gradually attenuates. By adjusting the heating temperature of the heating member 91, the amount of the flavour released from the flavour material is controlled, and a portion of the aerosol atomized by the atomizer 2 does not need to pass through the flavour component 3, such that the flavour concentration of the flavour material in the aerosol at the outlet portion 4 is adjusted, allowing the flavour concentration of the flavour material in the aerosol inhaled by the user remains uniform in the inhalation process.

In detail, at an early stage of operation, the flavour component 3 is not inhaled, and the flavour material in the flavour component 3 is not consumed. At this moment, at a lower temperature, the flavour material in the flavour component 3 may release a larger amount of flavour, such that a portion of the aerosol atomized by the atomizer 2 enters the second aerosol channel 82 to reach the aerosol mixing zone without passing through the flavour component 3, and subsequently enters the outlet portion 4. To a certain extent, the flavour concentration of the flavour material is diluted.

The flavour material in the flavour component 3 is consumed as inhalation proceeds. At this moment, the flavour concentration released from the flavour material in the flavour component 3 gradually decreases. The heating temperature of the heating member 91 may be increased to increase the flavour concentration released from the flavour material in the flavour component 3. Since a portion of the aerosol atomized by the atomizer 2 enters the second aerosol channel 82 to reach the aerosol mixing zone 83 without passing through the flavour component 3, and subsequently enters the outlet portion 4, a negative pressure is generated in the aerosol mixing zone 83, such that the flavour material in the flavour component 3 located in the first aerosol channel 81 may release the flavour more easily.

By defining the first aerosol channel 81 and the second aerosol channel 82, a portion of the aerosol atomized by the atomizer 1 reaches the aerosol mixing zone 83 through the flavour component 3 in the first aerosol channel 81, and the other portion of the aerosol reaches the aerosol mixing zone 83 through the second aerosol channel 82. The aerosol in the first aerosol channel 81 and the aerosol in the second aerosol channel 82 are mixed in the aerosol mixing zone 83, improving the effectivity of the flavour released by the flavour material, thus enhancing a taste and satisfaction of the aerosol. At the same time, the heating member 91 is arranged in the first heating component 9, the heating temperature of the heating member 91 is adjusted dynamically. The heating member 91 and the second aerosol channel 82 may function cooperatively to allow the flavour concentration of the flavour material to be uniform in the inhalation process, solving the problem of uneven release and severe attenuation of the flavour released by the flavour material in the art.

Furthermore, the electronic atomization device further includes a memory (not shown), which stores parameter information. The parameter information includes a preset value of the flavour member 3 that can be inhaled and a concentration of the flavour material corresponding to the number of inhalation times. The memory transmits the parameter information to the controller 6. The controller 6 compares the number of inhalation times detected by the airflow sensor 7 to the parameter information and controls the heating temperature of the heating member 91 in the first heating component 9 based on the comparison result. A temperature adjustment range of the heating member 91 in the first heating component 9 is 10° C.-380° C.

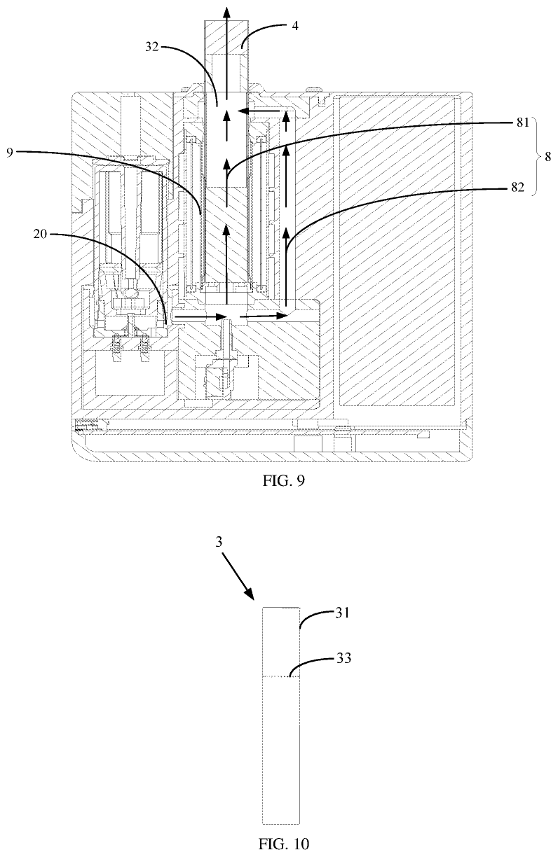

As shown in FIGS. 8-10, FIG. 8 is a structural schematic view of an electronic atomization device according to a third embodiment of the present disclosure, FIG. 9 is a schematic view of aerosols flowing in an aerosol channel of an electronic atomization device according to the third embodiment of the present disclosure, and FIG. 10 is a schematic view of a flavour component of the electronic atomization device according to the third embodiment of the present disclosure.

In a third embodiment, being the same as the first embodiment in that, divergence into the first aerosol channel and the second aerosol channel is formed between the outlet port of the outlet channel and the outlet portion of the atomizer. A difference between the third embodiment and the first embodiment refers to arrangement positions of the atomizer and the flavour component, a position at which the outlet port of the atomizer is defined, and a method of adjusting the concentration of the flavour material in the aerosol at the outlet portion.

The electronic atomization device includes a shell 1, an atomizer 2, a flavour component 3, an outlet portion 4, a battery 5, a controller 6, and an airflow sensor 7. In the present embodiment, the flavour component 3 is commonly referred to as a heated non-combustible cigarette.

The flavour component 3 includes a case 31 and a flavour material 36 received in the case 31. A first end of the case 31 defines an outlet portion 4. A cavity 32 is defined between the flavour material and the outlet portion 4. A side wall of the case 31 defines an air collection hole 33 corresponding to the cavity 32. Alternatively, the flavour material 36 includes a nicotine flavour.

In detail, the flavour component 3 further includes an absorbent material 37. The absorbent material 37 is received in the case 31 and disposed at the first end, and the flavour material 36 is disposed at a second end of the case 31. In other words, the absorbent material 37 is disposed at the outlet portion 4 to improve the user's experience. The absorbent material 37 and the flavour material 36 are respectively disposed at the two ends of the case 31, and the cavity 32 is defined between the absorbent material 37 and the flavour material 36.

It shall be understood that, the absorbent material 37 may be disposed at the outlet portion 4 or on a side of the outlet portion 4 near the flavour material 36. The flavour material 36 may be disposed at an end of the case 31 or in a middle of the case 31. In detail, the arrangement positions of the absorbent material 37 and the flavour material 36 may be determined based on demands, as long as the cavity 32 is defined between the flavour material 36 and the outlet portion 4.

The case 31 defines a plurality of air collection holes 33. The plurality of air collection holes are defined spaced apart from each other and around a circumference of the case 31. Arrangement of the plurality of air collection holes 33 may be determined based on demands, as long as an outside of the device is communicated to the cavity 32 through the air collection holes 33.

The shell 1 defines a receiving cavity 10. The atomizer 2, the flavour component 3, the battery 5, the controller 6 and the airflow sensor 7 are received in the receiving cavity 10 defined by the shell 1. The atomizer 2 is configured to atomize the matrix to be atomized to produce the aerosol. The atomizer 2 defines the atomization chamber and the outlet port 20 communicated to the atomization chamber. The aerosol atomized by the atomizer 2 flows out through the outlet port 20. The atomizer 2, the battery 5 and the airflow sensor 7 are electrically connected to the controller 6. The controller 6 controls the battery 5 to output the operating voltage to the atomizer 2 based on detection information of the airflow sensor 7 to allow the atomizer 2 to work. The user inhales the aerosol through the outlet portion 4.

In detail, the receiving cavity 10 defined by the shell 1 includes an atomizer mounting cavity 11, a flavour component mounting cavity 12, a battery mounting cavity 13, a controller mounting cavity and an airflow sensor mounting cavity 15. The atomizer 2 is received in the atomizer mounting cavity 11. The portion of the case 31 of the flavour component 3 receiving the flavour material 36 is received in the flavour component mounting cavity 12. That is, the portion of the flavour component 3 having the flavour material 36 is received in the flavour component mounting cavity 12. The battery 5 is received in the battery mounting cavity 13. The controller 6 is received in the controller mounting cavity 14. The airflow sensor 7 is received in the airflow sensor mounting cavity 15.

It shall be understood that, when the user inhales the aerosol directly through the outlet portion 4, the portion of the flavour component 3 having the flavour material 36 is received in the flavour component mounting cavity 12, and the outlet portion 4 defined at the end of the flavour component 3 is disposed outside the flavour component mounting cavity 12 for the user to inhale. Alternatively, a nozzle portion may be arranged on the shell 1, and the nozzle portion is communicated to the outlet portion 4. The entirety of the flavour component 3 is received in the flavour component mounting cavity 12. The user may inhale the aerosol through the nozzle portion.

In the present embodiment, the atomizer 2, the flavour component 3, and the battery 5 are disposed side-by-side. That is, the atomization mounting cavity 11, the flavour component mounting cavity 12, and the battery mounting cavity 13 are arranged side-by-side. The airflow sensor 7 is disposed directly below the flavour component 3. That is, the airflow sensor mounting cavity 15 is arranged directly below the flavour component mounting cavity 12. It shall be understood that a specific position of the airflow sensor 7 may be determined based on demands, as long as the airflow sensor 7 can sense a change in the airflow in the inhalation process. The controller 6 is disposed on a side of the airflow sensor away from the flavour component 3 and on a side of the atomizer 2 and the battery 5 away from the outlet portion 4. That is, the controller mounting cavity 14 is arranged on a side of the atomizer mounting cavity 11, the airflow sensor mounting cavity 15, and the battery mounting cavity 13 away from the outlet portion 4.

The outlet portion 4 is communicated to the outlet port 20 through the aerosol channel 8. The aerosol channel 8 diverges into the first aerosol channel 81 and the second aerosol channel 82 between the outlet port 20 and the outlet portion 4. That is, the aerosol channel 8 includes the first aerosol channel 81 and the second aerosol channel 82. The first aerosol channel 81 and the second aerosol channel 82 are defined between the outlet port 20 and the outlet portion 4 of the atomizer 2. The aerosol generated by the atomizer 2 passes through at least one of the first aerosol channel 81 and the second aerosol channel 82 to the outlet portion 4.

Further, the flavour material is received in the first aerosol channel 81. The portion of the case of the flavour component 3 having the flavour material 36 is received in the first aerosol passage 81. The first aerosol passage 81 allows the aerosol generated by the atomizer 2 to reach the outlet portion 4 via the flavour material 36, and the second aerosol passage 82 allows the aerosol generated by the atomizer 2 to reach the outlet portion 4 directly. In other words, after the aerosol atomized by the atomizer flows out through the outlet port 20, a portion of the aerosol flows through the flavour material 36 to reach the outlet portion 4, and the other portion of the aerosol reaches the outlet portion 4 directly without passing through the flavour material 36. Further, the aerosol in the second aerosol channel 82 passes through the air collection hole 33 to be mixed with the aerosol in the first aerosol channel 81 in the cavity 32, and subsequently enters the outlet portion 4.

In detail, a communication cavity 34 is defined between an outer surface of the case 31 of the flavour component 3 corresponding to the air collection hole 33 and the flavour component mounting cavity 12. The second aerosol channel 82 is communicated to the cavity 32 through the communication cavity 34 and the air collection hole 33. In other words, the aerosol in the second aerosol channel 82 enters the cavity 32 after passing through the communication cavity 34 and the air collection hole 33, and then mixes with the aerosol in the first aerosol channel 81 in the cavity 32. The mixed aerosol enters the outlet portion 4 and is inhaled by the user. That is, the aerosol in the first aerosol channel 81 and the aerosol in the second aerosol channel 82 are mixed in the flavour component 3. In one embodiment, a plurality of air collection holes 33 are defined in the case 31, and the plurality of air collection holes 33 are spaced apart from each other and around the circumference of the case 31. The communication cavity is defined between the outer surface of the case 31 of the flavour component 3 corresponding to the plurality of air collection holes 33 and the flavour component mounting cavity 12. The connecting cavity surrounds the circumference of the case 31, and the aerosol in the second aerosol channel 82 flows through the communication cavity 34 along the circumference of the case 31 and enters the cavity 32 through the plurality of air collection holes 33. In another embodiment, the air collection hole 33 is defined only at a position of the case 31 corresponding to an outlet port of the second aerosol channel 82. The communication cavity 34 is defined between the outer surface of the case 31 corresponding to the air collection hole 33 and the flavour component mounting cavity 12. In this case, one ore more air collection holes 33 may be defined, as long as the aerosol in the second aerosol channel 82 is able to enter the cavity 32.

A sealing member 35 is disposed between the outer surface of the case 31 and the flavour component mounting cavity 12 to prevent the aerosol that flows from the second aerosol channel 82 to the cavity 32 from being leaked. When the air collection hole 33 is defined only in the position of the case 31 corresponding to the outlet port of the second aerosol channel 82, the sealing member 35 is disposed between the outer surface of the air collection hole 33 and the flavour component mounting cavity 12. When the case 31 defines a plurality of air collection holes 33, and the plurality of air collection holes 33 are spaced apart from each other and around the circumference of the case 31, the sealing member 35 is disposed between the outer surface of the case 31 corresponding to the plurality of air collection holes 33 and the flavour component mounting cavity 12. That is, the sealing member 35 is disposed between the outer surface of the air collection holes 33 and the flavour component mounting cavity 12. The sealing member 35 surrounds the circumference of the case 31 and defines the communication cavity 34 communicating with the second aerosol channel 82. The arrangement of the sealing member 35 may be determined based on the arrangement of the air collection hole 33, in order to prevent leakage of the aerosol that flows from the second aerosol channel 82 into the cavity 32.

In the present embodiment, the atomizer 2, the flavour component 3 and the second aerosol channel 82 are disposed side-by-side, and the second aerosol channel 82 is defined on the side of the flavour component 3 away from the atomizer 2. In one embodiment, a cavity wall of the flavour component mounting cavity 12 is spaced from a cavity wall of the battery mounting cavity 13. That is, there is a gap between the cavity wall of the flavour component mounting cavity 12 and the cavity wall of the battery mounting cavity 13, and the gap between the cavity wall of the flavour component mounting cavity 12 and the cavity wall of the battery mounting cavity 13 serves as the second aerosol channel 82. An end of the second aerosol channel 82 is communicated to the outlet port 20 of the atomizer 2, and the other end of the second aerosol channel 82 is communicated to the outlet portion 4. In another embodiment, the cavity wall of the flavour component mounting cavity 12 is partially shared with the cavity wall of the battery mounting cavity 13. A through hole is defined in the shared cavity wall along the length of the electronic atomization device to form the second aerosol channel 82. An end of the second aerosol channel 82 formed in this way is communicated to the outlet port 20 of the atomizer 2, and the other end is communicated to the outlet portion 4. The arrangement of the second aerosol channel 82 may be determined based on demands, and will not be limited by the present disclosure.

In an embodiment, a structure of the atomizer 2 of the third embodiment may be identical to that of the first embodiment. That is, the outlet port 20 of the atomizer 2 is defined at an end of the atomizer 2 near the outlet portion 4 and is defined at a top of the atomizer 2. Since air inlets of the first aerosol channel 81 and the second aerosol channel 82 are defined at the end away from the outlet portion 4, in order to allow the outlet port 20 of the atomizer 2 to communicate with the air inlets of the first aerosol channel 81 and the second aerosol channel 82, a gap is defined between an outer surface of the atomizer 2 and an inner surface of the atomizer mounting cavity 11 to serve as an air channel to allow the aerosol atomized by the atomizer 2 to enter the aerosol channel 8.

In another embodiment, a structure of the atomizer 2 of the third embodiment is basically the same as that of the first embodiment. A different between the structure of the atomizer in the third embodiment and that in the first embodiment refers to positions at which the outlet port 20 and the air inlet of the atomizer 2 are defined. The outlet port 20 of the atomizer 2 is defined at an end of a side wall of the atomizer 2 away from the outlet portion 4; and the air inlet of the atomizer 2 is defined at an end of the atomizer 2 near the outlet portion 4 and is defined at the top of the atomizer 2. It shall be understood that the air inlet of the atomizer 2 of the third embodiment may be the same as that in the first embodiment. The outlet port 20 is defined at the end of the side wall of the atomizer 2 away from the outlet portion 4, saving a space for defining the air outlet channel in the first embodiment and increasing a space for the liquid storage space, and thus increasing the amount of the matrix to be atomized stored in the space. The arrangement of the air inlet of the atomizer 2 of the third embodiment is determined based on demands, and will not be limited by the present disclosure.

Since the air inlets of the first aerosol channel 81 and the second aerosol channel 82 are defined at the end away from the outlet portion 4, defining the outlet port 20 of the atomizer 2 at the end of the side wall of the atomizer 2 away from the outlet portion 4 may shorten a path that the aerosol atomized by the atomizer 2 flows into the first aerosol channel 81 and the second aerosol channel 82. In this way, generation of condensate may be reduced, the amount of aerosol at the outlet portion 4 may be improved, and the user's experience may be improved.

The electronic atomization device further includes the first heating component 9, configured to heat the flavour component 3 and adjust the flavour concentration of the flavour material 36 in the aerosol at the outlet portion 4. The first heating component 9 is electrically connected to the controller 6. The first heating component 9 is received in the flavour component mounting cavity 12 defined by the shell 1. Further, the first heating component 9 defines a receiving cavity 93 for receiving the flavour component 3.

In the present embodiment, the first heating component 9 includes a metal tube 94 and a heating member 91. The metal tube 94 defines the receiving cavity 93. It shall be understood that an internal space of the metal tube 94 serves as the receiving cavity 93. The portion of the case 31 of the flavour component 3 having the flavour material 36 is received in the internal space of the metal tube 94. The heating member 91 surrounds the outer surface of the metal tube 94 for heating the flavour component 3 to adjust the amount of the flavour released by the flavour material 36. The heating member may be one of a flexible circuit board, a thick film, and a metal heating sheet. In order to improve a heating efficiency of the heating member 91, the heating member 91 is attached to an outer surface of the metal tube 94.

In detail, the heating member 91 may be a sheet. The electronic atomization device includes a plurality of heating members 91, and the plurality of heating members 91 are spaced apart from each other and are arranged to surround the circumference of the flavour component 3. A spacing distance between the plurality of heating members 91 may be determined based on heating efficiencies of the heating members 91. At least a portion of the flavour component 3 (the portion of the flavour component having the flavour material 36) is received in a cavity defined by the plurality of heating members 91. That is, the portion of the flavour component 3 having the flavour material 36 is received in the cavity defined by the plurality of heating members 91. The portion of the flavour component 3 without the flavour material 36 may be received in the cavity defined by the plurality of heating members 91, or disposed out of the cavity defined by the plurality of heating members 91.

The heating member 91 may be ring-shaped and disposed on the circumference of the flavour component 3. In an embodiment, the electronic atomization device includes a plurality of heating members 91, and each of the plurality of heating members 91 is disposed on the circumference of the flavour component 3. The plurality of heating members 91 are spaced apart from each other along the length of the flavour component 3. A spacing distance may be determined based on the heating efficiencies of the plurality of heating members 91. The portion of the flavour component 3 having the flavour material 36 is received in a cavity defined by the plurality of heating members 91, and the portion of the flavour component 3 not having the flavour material 36 may be received in the cavity defined by the plurality of heating members 91, or may be disposed out of the cavity defined by the plurality of heating members 91. In another embodiment, the electronic atomization device includes one heating member 91, disposed on the circumference of the flavour component 3. The portion of the flavour component 3 having the flavour material 36 is received in the cavity defined by the heating member 91, the portion of the flavour component 3 not having the flavour material 36 may be received in the cavity defined by the heating member 91, or may be disposed out of the cavity defined by the heating member 91.

The electronic atomization device also includes a heat insulator 92, received in the flavour component mounting cavity 12 and is disposed on a side of the first heating component 9 away from the flavour component 3. The heat insulator 92 is spaced apart from the first heating component 9 to form air insulation between the heat insulator 91 and the first heating component 9, reducing a heat loss of the heating member 91 in the first heating component 9, and improving the heating efficiency of the heating member 91.

In order to achieve a better heat insulation effect, the heat insulator 92 may be ring-shaped and may be an integral and overall structure. The heating member 91 is completely received in the cavity defined by the heat insulator 92. Specific structures of the first heating component 9 and the heat insulator are determined based on demands, as long as the first heating component 9 can heat the flavour material 36 in the flavour component 3, and the heat insulator 92 can achieve heat insulation. It shall be understood that the heat insulator 92 is an optional structure.

It shall be understood that, the first heating component 9 and the portion of the case 31 of the flavour component 3 having the flavour material both are received in the flavour component mounting cavity 12. A fixing mechanism 121 is arranged on the cavity wall of the flavour component mounting cavity 12 to fix the first heating component 9 and the heat insulator 92. A fixing seat 122 is also received in the flavour component mounting cavity 12. The flavour component 3 is received in the receiving cavity defined by the metal tube 94 of the first heating component 9. The flavour component 3 is fixed by the fixing seat 122. The first heating component 9 and the heat insulator 92 are fixed again by the fixing seat 122. That is, an end of the flavour component 3 is fixed by the fixing seat 122; an end of the first heating component 9 and the heat insulator 92 are fixed to the fixing mechanism 121, and the other end is fixed to the fixing seat 122.

The controller 6 is electrically connected to the heating member 91 in the first heating component 9. The controller 6 controls the heating temperature of the heating member 91 in the first heating component 9 based on the number of inhalation times detected by the airflow sensor 7 to regulate the amount of flavour released by the flavour material 36, such that the flavour concentration of the flavour material 36 in the aerosol at the outlet portion 4 remains uniform as the atomizer 1 continuously operates.

It shall be understood that at different temperatures, the amount of flavour released from the flavour material in the flavour component 3 varies. The higher the temperature is, the more the flavour is released of the flavour material in the flavour component 3. As inhalation continues, the flavour of the flavour material in the flavour component 3 gradually attenuates. By adjusting the heating temperature of the heating member 91, the amount of the flavour released from the flavour material 36 is controlled, and a portion of the aerosol atomized by the atomizer 2 does not need to pass through the flavour component 3, such that the flavour concentration of the flavour material in the aerosol at the outlet portion 4 is adjusted, allowing the flavour concentration of the flavour material in the aerosol inhaled by the user remains uniform in the inhalation process.

In detail, at an early stage of operation, the flavour component 3 is not inhaled, and the flavour material in the flavour component 3 is not consumed. At this moment, at a lower temperature, the flavour material in the flavour component 3 may release a larger amount of flavour, such that a portion of the aerosol atomized by the atomizer 2 enters the second aerosol channel 82 to reach the cavity 32 without passing through the flavour component 3, and subsequently enters the outlet portion 4. To a certain extent, the flavour concentration of the flavour material is diluted.

The flavour material in the flavour component 3 is consumed as inhalation proceeds. At this moment, the flavour concentration released from the flavour material in the flavour component 3 gradually decreases. The heating temperature of the heating member 91 may be increased to increase the flavour concentration released from the flavour material in the flavour component 3. Since a portion of the aerosol atomized by the atomizer 2 enters the second aerosol channel 82 to reach the cavity 32 without passing through the flavour component 3, and subsequently enters the outlet portion 4, a negative pressure is generated in the cavity 32, such that the flavour material in the first aerosol channel 81 may release the flavour more easily.

By defining the first aerosol channel 81 and the second aerosol channel 82, a portion of the aerosol atomized by the atomizer 1 reaches the cavity 32 through the flavour material 36 in the first aerosol channel 81, and the other portion of the aerosol reaches the cavity 32 through the second aerosol channel 82 and the air collection hole 33. The aerosol in the first aerosol channel 81 and the aerosol in the second aerosol channel 82 are mixed in the cavity 32, improving the effectivity of the flavour released by the flavour material 36, thus enhancing a taste and satisfaction of the aerosol. At the same time, the heating member 91 is arranged in the first heating component 9, the heating temperature of the heating member 91 is adjusted dynamically. The heating member 91 and the second aerosol channel 82 may function cooperatively to allow the flavour concentration of the flavour material 36 to be uniform in the inhalation process, solving the problem of uneven release and severe attenuation of the flavour released by the flavour material 36 in the art.

Furthermore, the electronic atomization device further includes a memory (not shown), which stores parameter information. The parameter information includes a preset value of the flavour component 3 that can be inhaled and a concentration of the flavour material 36 corresponding to the number of inhalation times. The memory transmits the parameter information to the controller 6. The controller 6 compares the number of inhalation times detected by the airflow sensor 7 to the parameter information and controls the heating temperature of the heating member 91 in the first heating component based on the comparison result. A temperature adjustment range of the heating member 91 in the first heating component 9 is 10° C.-380° C.

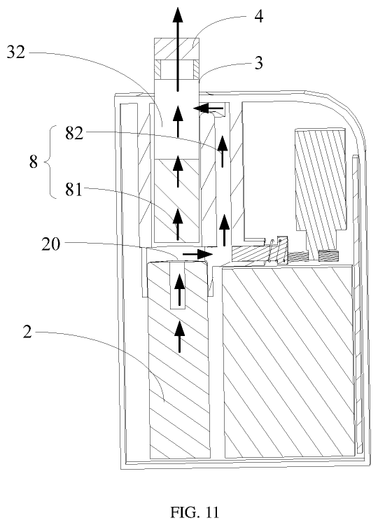

As shown in FIG. 11, FIG. 11 is a schematic view of aerosols flowing in an aerosol channel of an electronic atomization device according to a fourth embodiment of the present disclosure.

The difference between the fourth embodiment and the first embodiment refers to the structure of the flavour component.

In the fourth embodiment, the arrangement of the atomizer, a relative position between the atomizer and the flavour component and the second aerosol channel, and the arrangement of the adjustment member are the same as those the first embodiment, and will not be repeated. The structure of the flavour component in the fourth embodiment is the same as that in the third embodiment, and will not be repeated.

The atomizer 2 is coaxially arranged with the flavour component 3, and the atomizer 2 is disposed at an end of the flavour component 3. A gap is defined between the atomizer 2 and the flavour component 3. The air inlet of the second aerosol channel 82 is misaligned with the outlet port 20 of the atomizer 2, and the second aerosol channel 82 is communicated with the outlet port 20 through the gap. The second aerosol channel 82 is disposed in parallel to the flavour component 3. A facing direction of the air inlet of the second aerosol channel 82 is substantially the same as the length direction of the flavour component 3. The aerosol in the first aerosol channel 81 and the aerosol in the second aerosol channel 82 are mixed in the cavity 32 and then enter the outlet portion 4.

It shall be understood that, dynamic adjustment of the flavour concentration of the flavour material in the aerosol at the outlet portion may be achieved by changing the heating temperature that the first heating component heats the flavour material of the flavour component, or by changing the amount of aerosol that reaches the outlet portion through the second aerosol channel. In this way, the flavour of the flavour material inhaled by the user may be uniform. The atomizer and the flavour component may be disposed side by side or coaxially. The aerosol of the first aerosol channel and the aerosol of the second aerosol channel may be mixed in or out of the flavour component. The structure of the flavour component may be adjusted based on demands. The above-mentioned embodiments may be combined in any way based on demands.

The above-mentioned are only some embodiments of the present disclosure, but do not limit the scope of the present disclosure. Any equivalent device or equivalent process transformation performed based on the contents of the specification and the accompanying drawings of the present disclosure, applied directly or indirectly in other related art, shall be equally included in the scope of the present disclosure.

What is claimed is:

1. An electronic atomization device, comprising a receiving chamber for receiving an atomizer and a flavour component, wherein,
the atomizer is configured to atomize a matrix to be atomized to produce an aerosol, the atomizer defines an atomization chamber and an outlet channel communicated to the atomization chamber, the aerosol is capable of flowing to an outside through the outlet channel;
the flavour component comprises a flavour material; and
the electronic atomization device comprises:
an outlet portion, communicated to the outlet channel through an aerosol channel, wherein the aerosol channel is divided into a main aerosol channel and an auxiliary aerosol channel between an outlet port of the outlet channel of the atomizer and the outlet portion, the main aerosol channel is configured to guide the aerosol produced by the atomizer to flow through the flavour component to reach the outlet portion, and the auxiliary aerosol channel is configured to guide the aerosol produced by the atomizer to reach the outlet portion directly; and
an adjustment member, received in the aerosol channel and configured to adjust an amount of aerosol that flows through the auxiliary aerosol channel to reach the outlet portion.

2. The electronic atomization device according to claim 1, wherein the adjustment member is disposed at an inlet port or an outlet port of the auxiliary aerosol channel and is configured to change a size of the inlet port or a size of the outlet port of the auxiliary aerosol channel.

3. The electronic atomization device according to claim 1, further comprising a housing, wherein the atomizer and the flavour component are arranged inside the housing, the auxiliary aerosol channel is defined between the flavour component and the housing.

4. The electronic atomization device according to claim 1, wherein the atomizer and the flavour component are arranged coaxially, a gap is defined between the atomizer and the flavour component; and
the inlet port of the auxiliary aerosol channel is misaligned to the outlet port of the outlet channel of the atomizer, the auxiliary aerosol channel is communicated to the outlet channel through the gap.

5. The electronic atomization device according to claim 4, wherein an extension direction of the auxiliary aerosol channel is parallel to an extension direction of the flavour component, a facing direction of the inlet port of the auxiliary aerosol channel is the same as a length direction of the flavour component.

6. The electronic atomization device according to claim 2, wherein the adjustment member is disposed at the inlet port of the auxiliary aerosol channel, and a moving direction of the adjustment member is perpendicular to the facing direction of the inlet port of the auxiliary aerosol channel.

7. The electronic atomization device according to claim 6, further comprising: a drive assembly; wherein the drive assembly is connected to the adjustment member and is configured to move the adjustment member; the controller is further configured to control the drive assembly to operate.

8. The electronic atomization device according to claim 7, wherein the drive assembly comprises a motor and a rotation table; the rotation table is connected to the motor, the adjustment member is connected to the rotation table; the motor is configured to apply a driving force to drive the rotation table to rotate, and the rotation table is configured to drive the adjustment member to move gradually block the inlet port of the auxiliary aerosol channel; and
the adjustment member is arranged with an elastic member, the elastic member is configured to reset the adjustment member to an original position when the motor stops applying the driving force.

9. The electronic atomization device according to claim 7, further comprising a controller, wherein the controller is configured to control the adjustment member via the drive assembly based on the detected number of inhalation times to adjust the size of the inlet port of the auxiliary aerosol channel, such that a concentration of the flavour material in an inhalation process is adjusted.

10. The electronic atomization device according to claim 9, wherein the controller is configured to compare the detected number of inhalation times to parameter information and configured to control the drive assembly based on a comparison result; and the parameter information comprises a predetermined inhalation value of the flavour component and a concentration of the flavour material corresponding to the number of inhalation times.

11. The electronic atomization device according to claim 9, wherein the controller is configured to control the adjustment member completely unblock the inlet port of the auxiliary aerosol channel and configured to control the adjustment member to gradually reduce the size of the inlet port of the auxiliary aerosol channel while the atomizer is being used.

12. An electronic atomization device, comprising an atomizer and a flavour component, wherein,
the atomizer is configured to atomize a matrix to be atomized to produce an aerosol, the atomizer defines an atomization chamber and an outlet port communicated to the atomization chamber, the aerosol is capable of flowing to an outside from the outlet port, the flavour component comprises a flavoring material; wherein,
the electronic atomizing device comprises an outlet portion;
the electronic atomizing device defines a first aerosol channel and a second aerosol channel, the first aerosol channel and the second aerosol channel are located between the outlet port of the atomizer and the outlet portion, the aerosol produced by the atomizer is capable of passing through at least one of the first aerosol channel and the second aerosol channel to reach the outlet portion; and
the electronic atomization device comprises a first heating component, configured to heat the flavour component.

13. The electronic atomization device according to claim 12, wherein a flavour material is received in the first aerosol channel.

14. The electronic atomization device according to claim 13, further comprising a controller, wherein the controller is configured to control a heating temperature of the first heating component based on the detected number of inhalation times in order to regulate an amount of the flavour material released by the atomizer so that a concentration of the flavour material in the aerosol at the outlet portion is uniform.

15. The electronic atomization device according to claim 13, further comprising a housing, wherein the housing defines a receiving cavity to receive the atomizer and the flavour component; and the flavour component is received in the first aerosol channel, the outlet portion is integrally formed with the housing.

16. The electronic atomization device according to claim 15, wherein the flavour component is disposed near an end of the outlet portion and is spaced apart from the outlet portion, an aerosol mixing zone is defined between the flavour component and the end of the outlet portion, and an aerosol in the first aerosol channel and an aerosol in the second aerosol channel are mixed in the aerosol mixing zone and are capable of entering the outlet portion.

17. The electronic atomization device according to claim 13, wherein the flavour component comprises a case and the flavour material received in the case; the outlet portion is formed at an end of the case; a cavity is defined between the flavour material and the outlet portion; a side wall of the case defines an air collection hole corresponding to the cavity; and
a portion of the case having the flavour material is received in the first aerosol channel; the aerosol in the second aerosol channel is capable of passing through the air collection hole and mixing with the aerosol in the first aerosol channel in the cavity, and the mixed aerosols are capable of entering the outlet portion.

18. The electronic atomization device according to claim 17, further comprising a shell, wherein,
the first heating component and the portion of the case having the flavour material are received in a flavour component mounting cavity defined by the shell;
a connecting cavity is defined between an outer surface of the case corresponding to the air collection hole and the flavour component mounting cavity; and
the second aerosol channel is communicated to the cavity through the connecting cavity and the air collection hole.

19. The electronic atomization device according to claim 18, wherein a sealing member is disposed between the outer surface of the case corresponding to the air collection hole and the flavour component mounting cavity to prevent the aerosol that flows from the second aerosol channel into the cavity from being leaked.

20. The electronic atomization device according to claim 14, wherein the atomizer, the flavour component and the second aerosol channel are arranged side-by-side, and the second aerosol channel is arranged on a side of the flavour component away from the atomizer; and
the outlet port is defined at an end of a side wall of the atomizer away from the outlet portion.
